(19) United States
(12) Patent Application Publication
(10) Pub. No.: US 2011/0242139 A1
(43) Pub. Date: Oct. 6, 2011

(54) DISPLAY DRIVER

(75) Inventors: Goki Toshima, Tachikawa (JP); Yasuyuki Kudo, Tokyo (JP); Yoshiki Kurokawa, Tokyo (JP); Akihito Akai, Kawasaki (JP)

(73) Assignee: RENESAS TECHNOLOGY CORP.

(21) Appl. No.: 12/750,781

(22) Filed: Mar. 31, 2010

(51) Int. Cl. G09G 5/10

(52) U.S. Cl. 345/690; 345/89

(57) ABSTRACT

The display driver achieves the balance between the image quality and power-cutting ratio by controlling the backlight dimming ratio to keep the image quality after backlight dimming constant. The display driver uses e.g. MSE (Mean Square Error) as an index of image quality. The reference gradation control unit controls the data decompression and backlight dimming ratios, thereby to keep the image quality after backlight dimming constant. Assuming display data decompression, and backlight dimming, the error calculating unit calculates a decrease of luminance for an input displayed image as MSE based on the decompression and dimming ratios of a preceding frame, in advance. In the case of MSE over a predetermined value, the decompression unit and light-adjustment control unit decrease the decompression and dimming ratios to below those of the preceding frame, respectively. In the case of MSE below the value, the ratios are lowered to below those of the preceding frame.

### FIELD OF THE INVENTION

The present invention relates to a display driver operable to control for dimming a backlight in response to decompression of image data. Particularly it relates to a technique useful in application to e.g. a liquid crystal display system.

### BACKGROUND OF THE INVENTION

In recent years, liquid displays are incorporated in battery-driven information devices, mobile phones and others. Most of such displays are of a transmission or translucent type which needs a backlight. Today large part of the power consumption of a liquid crystal display is attributed to a backlight. Hence, it is necessary to devise means for reducing such power consumption. Especially, in regard to mobile phones, it has become possible to watch moving pictures of e.g. TV programs on them. Therefore, it has been required to drive mobile phones by batteries for a long time with their displays kept in action.

Examples of the means for reducing the power consumption of backlight include the way as described by Published Unexamined Patent Application JP-A-11-65531. For instance, on condition that a backlight emits light at a 100-percent output power, and the light passes through a liquid crystal cell lying in front of it at a transmission of 80 percent, 80 percent of the light can be seen. In this case, in spite of 100-percent light emission that the backlight achieves, the liquid crystal cell cuts 20 percent thereof. In contrast, on condition that the backlight radiates light at a 80-percent output power, and the liquid crystal cell allows 100 percent of the light to pass therethrough, 80 percent of the light can be seen likewise. However, in this case, the light emission of the backlight can be reduced to 80 percent. By making use of the difference as described above, the light emission of the backlight is suppressed in quantity.

In a case where a pixel of a 80-percent luminance takes the maximum in the histogram of pixel values of an image, exactly the same image can be displayed with a quantity of light emission of 80 percent by decompressing display data to five-forth thereof, and reducing in quantity the light emission of a backlight to 80 percent.

An image can be displayed with a smaller amount of light emission in comparison to the way of utilizing the maximum luminance of the image by using the histogram to take the following procedure: decompressing image data so that gradation data Ds corresponding, in appearance frequency, to a predetermined value of x percent with respect to the maximum value forms the maximum gradation; and then dimming a backlight according to the decompression.

Published Unexamined Patent Application JP-A-2006-308632 discloses an image display technique, which includes: conducting conversion of enlargement of the distribution of gradations on image data; and at the time of controlling or adjusting, in quantity, the light of a backlight according to the enlargement, controlling the gradations of the image data so as to reduce the change in brightness resulting from the adjustment of the light. According to the patent document JP-A-2006-308632, gradation values of the image data are corrected so that the product of the average of gradation values of image data subjected to the conversion of enlargement of the distribution of gradations, and the light adjustment factor becomes closer to the average of gradation values of the image data before the conversion.

### SUMMARY OF THE INVENTION

Prior to the invention, the inventors were involved in research and development of a liquid crystal driver semiconductor integrated circuit intended to be incorporated in a mobile phone.

In the research and development, the inventors conducted a detailed study of the related art concerning a technique for reducing the power requirements of backlights as described in Published Unexamined Patent Application JP-A-11-65531. After the study, the inventors clarified the problem that the adoption of the conventional technique makes difficult to sufficiently decompress display data in connection with a pixel of a higher gradation in comparison to the gradation Ds corresponding to the predetermined value of x percent, and therefore dimming a backlight decreases the luminance of a pixel of a higher gradation. In addition, it was revealed that the amount of decrease in luminance varied depending on which image to display. Therefore, to use the conventional technique to achieve the image quality over a certain level in regard to all displayed images, it is essential to set the predetermined value of x percent to a smaller value so that even with a displayed image, whose quantity of decrease in luminance is the worst, the absolute value of the amount of decrease in luminance is made smaller. In this case, the image quality over a certain level can be ensured. However, the effect of cutting backlight's power consumption becomes smaller for all images. According to the patent document JP-A-2006-308632, the gradation values of image data are corrected so that the display mean value luminances before and after the conversion for enlargement of the distribution of gradations agree with each other. Sometimes it is not expected that the control taking the step of conforming the display mean value luminances to each other by the luminance mean can increase the image quality after correction.

After the study prior to the invention as described above, the invention was made by the inventors.

It is an object of the invention to provide a display driver which controls the ratio of backlight dimming so that the image quality after backlight dimming is kept at a constant level for every displayed image, and which can achieve a balance between the image quality and power cutting ratio.

The above and other objects of the invention and novel features thereof will be apparent from the description hereof and the accompanying drawings.

Of the embodiments of the invention herein disclosed, representative one will be briefly outlined below.

A means in connection with a display driver according to an embodiment of the invention is characterized by using e.g. MSE (Mean Square Error) or PSNR (Peak Signal to Noise Ratio) as an index of image quality to control the data decompression ratio and backlight dimming ratio so that the image quality after backlight dimming is at a constant level. As an example of the controlling means, a method using MSE will be briefly described below. Incidentally, the same as the description presented here is true for a method using PSNR. First, the amount of decrease in luminance for an input displayed image in the case of decompressing display data and dimming a backlight is previously calculated, as MSE, based on the data decompression ratio and backlight dimming ratio of a preceding frame. If the MSE is larger than a predetermined reference value, the data decompression ratio and backlight dimming ratio are made smaller than those of the preceding frame. In contrast, if e MSE is smaller than the predetermined reference value, the data decompression ratio and backlight dimming ratio are made smaller than those of the preceding frame. Using the control as described above, MSE or PSNR of an output displayed image, namely an index of image quality thereof, is made the predetermined reference value regardless of a displayed image.

The effect achieved by the representative embodiment of the invention herein disclosed will be briefly described below.

With a technique for reducing the power requirements of backlights which includes decompressing display data and dimming a backlight according to the invention, it becomes possible to control the backlight dimming ratio so that the image quality after backlight dimming is kept fixed.

### BRIEF DESCRIPTION OF THE DRAWINGS

FIG. 1 is a block diagram showing a liquid crystal display system using a liquid crystal display driver, i.e. LC driver, according to the first embodiment of the invention;

FIG. 2 is a block diagram showing the first example of a backlight control circuit used in the LC driver shown in FIG. 1;

FIG. 3A is a diagram for explaining an internal action of the MSE calculating circuit in the backlight control circuit in connection with the first embodiment, which shows the relation between a gradation value of input display data and a display luminance;

FIG. 3B is a diagram for explaining an internal action of the MSE calculating circuit in the backlight control circuit in connection with the first embodiment, which shows the relation between a gradation value of input display data and an output gradation;

FIG. 3C is a diagram for explaining an internal action of the MSE calculating circuit in the backlight control circuit in connection with the first embodiment, which shows the relation between a gradation value of input display data and a value of error;

FIG. 4A is a diagram showing the relation between register values and errors as a means for setting the image quality of output display for the backlight control circuit in connection with the first embodiment;

FIG. 4B is a diagram showing that the backlight power cutting ratio varies among different displayed images on condition that the image quality of output display for the backlight control circuit in connection with the first embodiment is fixed;

FIG. 5 is a block diagram showing the second example of the backlight control circuit used in the LC driver shown in FIG. 1;

FIG. 6A is a diagram for explaining the concept concerning the step of grasping the difference in luminance between adjacent image data used in the step of judging a solid image;

FIG. 6B is a diagram for explaining the procedure of the step of judging a solid image in the backlight control circuit of FIG. 5;

FIG. 7 is a diagram for explaining the way of setting a reference value weighting coefficient in the backlight control circuit of FIG. 5;

FIG. 8 is a block diagram showing the third example of the backlight control circuit used in the LC driver shown in FIG. 1;

FIG. 9 is a diagram for explaining the way of setting a reference value weighting coefficient in the backlight control circuit of FIG. 8;

FIG. 10 is a diagram for explaining an effect of the backlight control circuit shown in FIG. 11, which is the fourth example of the backlight control circuit used in the LC driver shown in FIG. 1;

FIG. 11 is a block diagram showing the fourth example of the backlight control circuit of the LC driver shown in FIG. 1;

FIG. 12A is a diagram for explaining the effect that errors are uniformized in division areas, which is achieved by the LC driver shown in FIG. 13;

FIG. 12B is a diagram for explaining the effect that luminances of division areas are treated on an individual division area basis, which is achieved by the LC driver shown in FIG. 13; and

FIG. 13 is a block diagram showing a liquid crystal display system using an LC driver according to the second embodiment of the invention.

### DETAILED DESCRIPTION OF THE PREFERRED EMBODIMENTS

### 1. Brief Description of the Preferred Embodiments

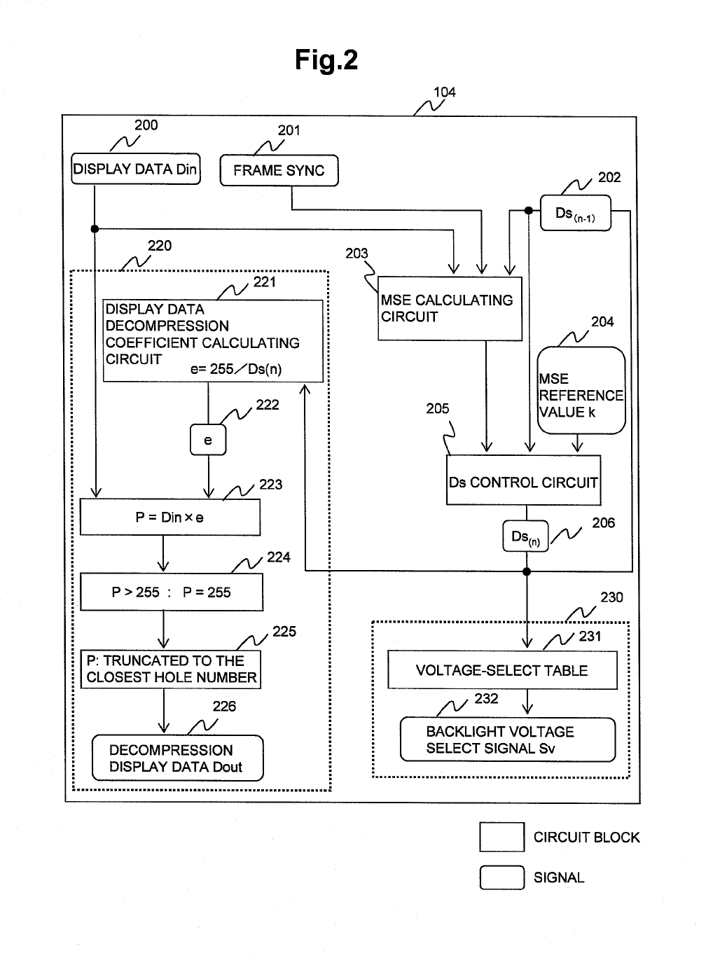

The preferred embodiments of the invention herein disclosed will be outlined, first. Here, the reference numerals, characters and signs for reference to the drawings, which are accompanied with paired round brackets, only exemplify what the concepts of members or parts referred to by the numerals, characters and signs contain.

[1] A display driver in connection with the invention (see FIG. 2) is operable to drive a display panel in response to input display data, and it includes: a decompression unit (220) which accepts input of a reference gradation (Ds₍ₙ₎), and decompresses the input display data so as to maximize the reference gradation; a light-adjustment control unit (230) which adjusts light of a backlight in response to the reference gradation; an error calculating unit (203) which calculates an error between a display luminance corresponding to the input display data and a display luminance after adjustment of light of the backlight; and a reference gradation control unit (205) which changes the reference gradation so that a result of the error calculation by the error calculating unit becomes equal to a first reference value.

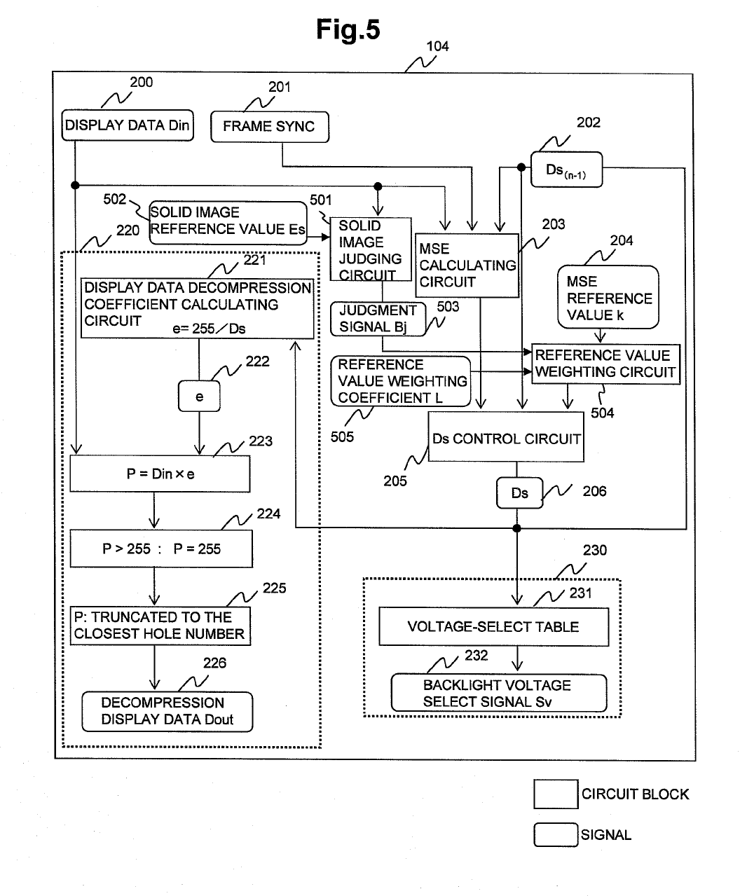

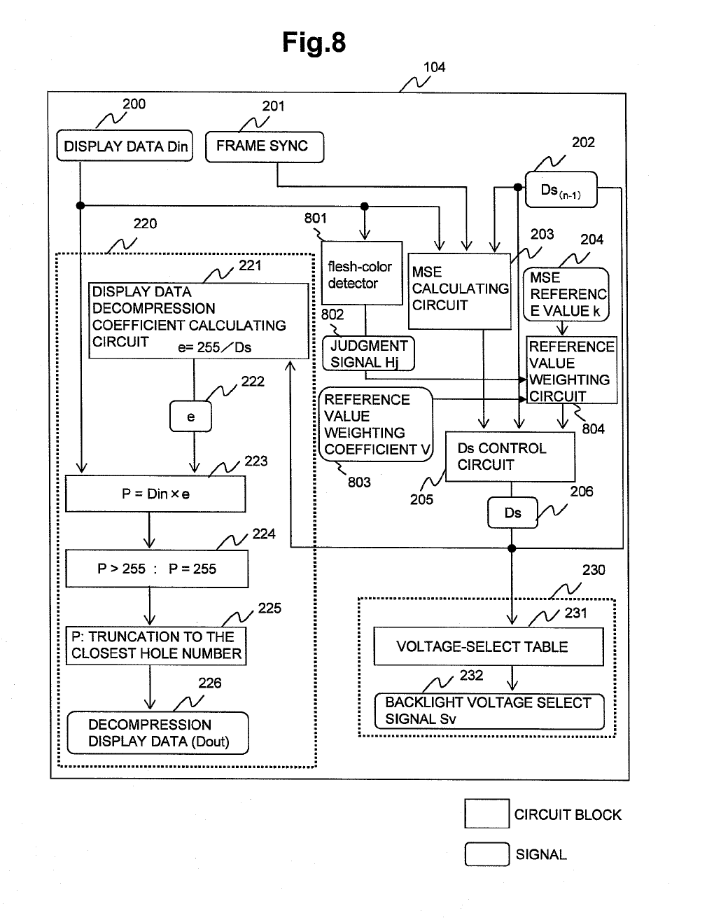

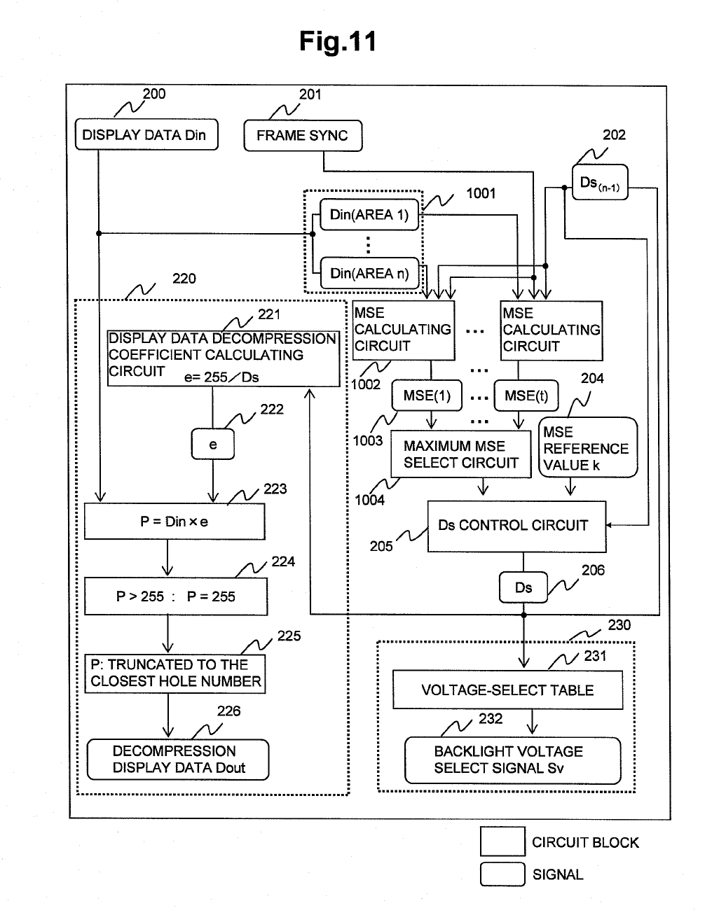

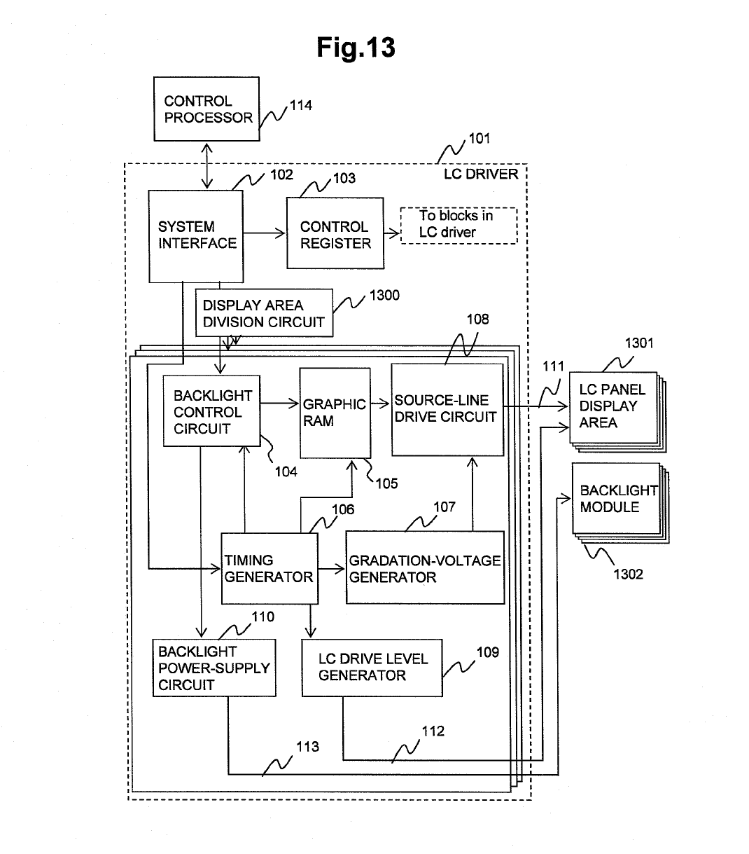

According to the above means, the reference gradation is changed so that an error between a display luminance corresponding to display data, and a display luminance after light adjustment becomes equal to a first reference value, and the decompression ratio for current display data, and the dimming ratio pertinent to the display panel are determined. The image quality after backlight dimming is easier to keep at a constant level in comparison to a control method such that the display mean luminances before and after the conversion are simply brought into agreement with each other.

[2] In the display driver described in [1], the decompression unit multiplies a value of each pixel component of display data by a coefficient to maximize the reference gradation, thereby to decompress the display data.

[3] In the display driver described in [1], the error calculating unit calculates an error between a luminance of display data of a current display frame, and a luminance obtained by decompressing the display data of the current display frame by use of a reference gradation of a preceding display frame.

[4] In the display driver described in [1], MSE (Mean Square Error) is used as the error.

[5] In the display driver described in [1], the first reference value in connection with the reference gradation control unit can be changed by a value set in a register from outside the display driver.

[6] In the display driver described in [4], in the gradation control unit, a gradation number of the reference gradation varied in every frame is changed as to a value set in a register from outside the display driver, or a numerical value of MSE (Mean Square Error).

[7] From another perspective, a display driver in connection with the invention (FIG. 5) drives a display panel in response to input display data, and it includes: a decompression unit (220) which accepts input of a reference gradation, and decompresses the input display data so as to maximize the reference gradation; a light-adjustment control unit (230) which adjusts light of a backlight in response to the reference gradation; an error calculating unit (203) which calculates MSE (Mean Square Error) between a display luminance corresponding to the input display data and a display luminance after adjustment of light of the backlight; an identical gradation value percentage judging unit (501) which judges, of the display data input for a duration of one frame, a percentage of gradation data having identical gradation values; and a gradation control unit (205) which changes the reference gradation so that a result of the MSE calculation by the error calculating unit becomes equal to one of first and second reference values, according to a result of judgment made by the identical gradation value percentage judging unit. The gradation control unit changes the reference gradation by use of the first reference value on condition that of the display data input for a duration of one frame, the percentage of gradation data having identical gradation values is smaller than a third reference value. However, the gradation control unit changes the reference gradation by use of the second reference value on condition that of the display data input for a duration of one frame, the percentage of gradation data having identical gradation values is larger than the third reference value. Thus, it is possible to achieve a lower power consumption in the time of displaying a solid image in comparison to the display driver described in [1].

[8] In the display driver described in [7], wherein the first to third reference values can be each changed by a value set in a register from outside the display driver.

[9] The display driver described in [8], wherein the second reference value is larger than the first reference value, which is one of requirements to achieve a lower power consumption.

[10] In regard to the display driver described in [9], in the gradation control unit, the difference between reference gradations before and after the change thereof is changed as to a value set in a register from outside the display driver, or a numerical value of MSE (Mean Square Error).

[11] From another perspective, a display driver in connection with the invention (FIG. 8) drives a display panel in response to input display data, and it includes: a decompression unit (220) which accepts input of a reference gradation, and decompresses the input display data so as to maximize the reference gradation; a light-adjustment control unit (230) which adjusts light of a backlight in response to the reference gradation; an error calculating unit (203) which calculates MSE (Mean Square Error) between a display luminance corresponding to the input display data and a display luminance after adjustment of light of the backlight; a flesh color percentage judging unit (801) which judges a percentage of the display data input for a duration of one frame occupied by information of being flesh-colored; and a gradation control unit (205) which changes the reference gradation so that a result of the MSE calculation by the error calculating unit becomes equal to one of first and fourth reference values, according to a result of judgment made by the flesh color percentage judging unit. The gradation control unit changes the reference gradation by use of the first reference value on condition that the percentage of the input display data occupied by information of being flesh-colored is smaller than the fifth reference value. However, the gradation control unit changes the reference gradation by use of the fourth reference value on condition that the percentage of the display data input for the duration of one frame occupied by information of being flesh-colored is larger than the fifth reference value. Thus, it is possible to achieve a higher image quality in flesh color display in comparison to the display driver described in [1].

[12] In the display driver described in [11], the percentage judging unit operable to judge flesh color has: the function of translating the input display data into all or one of hue, color saturation, and lightness; and the function of identifying flesh color from all or one of the hue, color saturation and lightness.

[13] In the display driver described in [11], the first, fourth and fifth reference values can be changed by a value set in a register from outside the display driver.

[14] In the display driver described in [13], the fourth reference value is smaller than the first reference value, which is one of requirements to increase the image quality.

[15] The display driver described in [14], in the gradation control unit, a gradation number of the reference gradation varied in every frame is changed as to one of a value set in a register from outside the display driver, and a numerical value of MSE (Mean Square Error).

[16] From still another perspective, a display driver in connection with the invention (FIG. 11) drives a display panel in response to input display data, and it includes: a decompression unit which accepts input of a reference gradation, and decompresses the input display data so as to maximize the reference gradation; a light-adjustment control unit which adjusts light of a backlight in response to the reference gradation; an error calculating unit which calculates MSE (Mean Square Error) between a display luminance corresponding to the input display data and a display luminance after adjustment of light of the backlight, for each of the displayed areas of the display panel; and a reference gradation control unit which changes the reference gradation so that a maximum of results of the error calculations on an individual displayed area basis by the error calculating unit becomes equal to the first reference value. Using this arrangement, the backlight dimming ratio can be decided so that the error is at or above a certain level as to any division area (display area) of the display panel. Therefore, it is possible to keep a better image display quality.

[17] In the display driver described in [16], the first reference value can be changed by a value set in a register from outside the display driver.

[18] In the display driver described in [17], in the gradation control unit, a gradation number of the reference gradation varied in every frame is changed as to one of a value set in a register from outside the display driver, and a numerical value of MSE (Mean Square Error).

[19] From another perspective, a display driver in connection with the invention (FIG. 13) individually drives displayed areas of a display panel in response to input display data, and it includes: a decompression unit which accepts input of a reference gradation for each displayed area, and decompresses the input display data so as to maximize the reference gradation; a light-adjustment control unit which adjusts light of a backlight for the displayed area to be handled in response to the reference gradation of the displayed area; an error calculating unit which calculates MSE (Mean Square Error) between a display luminance corresponding to the input display data, and a display luminance after adjustment of light of the backlight, for each of the displayed areas of the display panel; and a reference gradation control unit which changes the reference gradation so that a maximum of results of the error calculations on an individual displayed area basis by the error calculating unit becomes equal to the first reference value. Using this arrangement, the backlight dimming ratio can be decided so that the error is kept unchanged as to any division area (display area) of the display panel. Therefore, it is possible to keep a better image display quality in comparison to the display driver described in [16].

[20] In the display driver described in [19], the first reference value can be changed by a value set in a register from outside the display driver.

[21] In the display driver described in [20], in the gradation control unit, a gradation number of the reference gradation varied in every frame is changed as to one of a value set in a register from outside the display driver, and a numerical value of MSE (Mean Square Error).

### 2. Further Detailed Description of the Preferred Embodiments

The embodiments will be described further in detail.

<<Liquid Crystal Display Driver>>

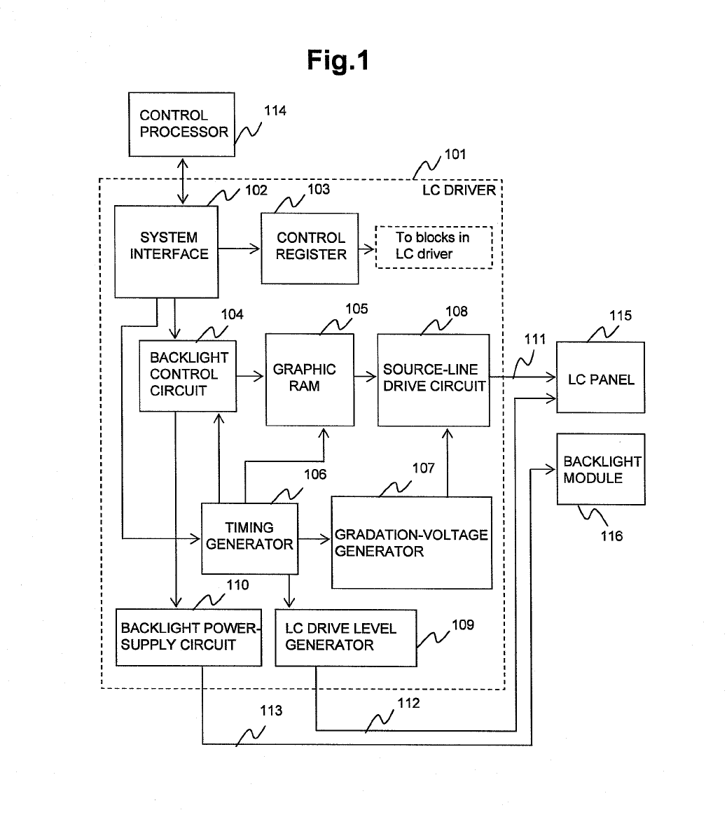

FIG. 1 shows an example of a liquid crystal display system having a liquid crystal display driver according to the first embodiment of the invention. The “liquid crystal display driver” is hereinafter referred to as “LC driver” for short, and LC is an abbreviation for “liquid crystal”. In the drawing, the reference numeral 101 represents the LC driver. The numerals 102 to 110 each represent an internal block of the LC driver 101. The system interface 102 serves to pass e.g. display data and data to be written in a control register for controlling each block of the LC driver to the internal block from the outside of the LC driver 101 and to perform the contrary. The control register 103 is a set of registers for controlling the blocks of the LC driver. The backlight control circuit 104 is a circuit block—a key feature of the invention, and it receives display data coming from the system interface 102, performs the step of decompressing the display data, which is to be described later, and transfers the resulting data to the graphic RAM 105. Also, the backlight control circuit 104 sends a signal for controlling the voltage of the backlight power source to the backlight power-source circuit 110. The graphic RAM 105 serves as a buffer which receives and stores display data, and transmits display data to the source-line drive circuit 108. The timing generator 106 generates an action timing of the whole LC driver 101 based on a content of the control register 103. The gradation-voltage generator 107 generates a gradation voltage used by the source-line drive circuit 108. The source-line drive circuit 108 selects a certain voltage from among gradation voltages generated by the gradation-voltage generator 107 according to the display data coming from the graphic RAM 105, and outputs the selected voltage as a source signal 111 to a source terminal of the LC panel 115. The LC drive level generator 109 generates gate and common signals 112 used to drive the liquid crystal, outputs the signals gate and common terminals of the LC panel 115, respectively. The backlight power-source circuit 110 generates a desired voltage based on the information from the backlight control circuit 104, sends out to a backlight-power-source line 113. Further, on receipt of lighting and extinction instructions from the control register 103, the backlight power-source circuit 110 generates voltages for lighting and extinction, and supplies them to the backlight-power-source line 113.

The control processor 114, LC panel 115 and backlight module 116 are disposed as external blocks. The control processor 114 transmits display data to the LC driver 101 through the system interface 102. The LC panel 115 receives the source signal 111, and gate and common signals 112 from the LC driver 101, and then offers a display. On receipt of supply of power source from the LC driver 101 through the backlight-power-source line 113, the backlight module 116 turns on the backlight. Then, the backlight illuminates the LC panel 115 at a desired brightness. Consequently it becomes possible to see a display on the LC panel 115 by visible light.

Using the blocks, the LC driver 101 works as follows. The LC driver 101 captures display data from the outside through the system interface 102, in which the display data is transferred to the backlight control circuit 104. The backlight control circuit 104 performs the step of decompressing the display data to be described later, and stores the resulting data in the graphic RAM 105. The timing generator 106 generates a timing signal to read the graphic RAM 105, and transmits the display data to the source-line drive circuit 108 in synchronization with the timing signal. The source-line drive circuit 108 selects a voltage from among gradation voltages generated by the gradation-voltage generator 107 according to display data as described above, and sends the selected voltage as the source signal 111 to the LC panel 115. In addition, the timing signal generated by the timing generator 106 is used to produce gate and common signals 112 in the LC drive level generator 109. The signals thus produced are also sent to the LC panel 115. Further, the backlight power-source circuit 110 generates a voltage according to information from the backlight control circuit 104. The voltage is applied to the backlight-power-source line 113, causing the backlight module 116 to go on. The backlight thus activated illuminates the LC panel 115, and therefore it becomes possible to see a display. The control processor 104 performs the lighting and extinction of the backlight as follows. First, the information for lighting/extinction is written in the control register 104 through the system interface 102, and then transmitted to the backlight power-source circuit 110. Subsequently, the backlight power-source circuit 110 produces a voltage for lighting/extinction, which is applied to the backlight-power-source line 113. Then, the backlight module 116 goes on/out. A signal for the action of such lighting or extinction has priority over a signal for controlling the voltage of the backlight power source, which the backlight control circuit 104 generates.

<<Backlight Control Circuit>>

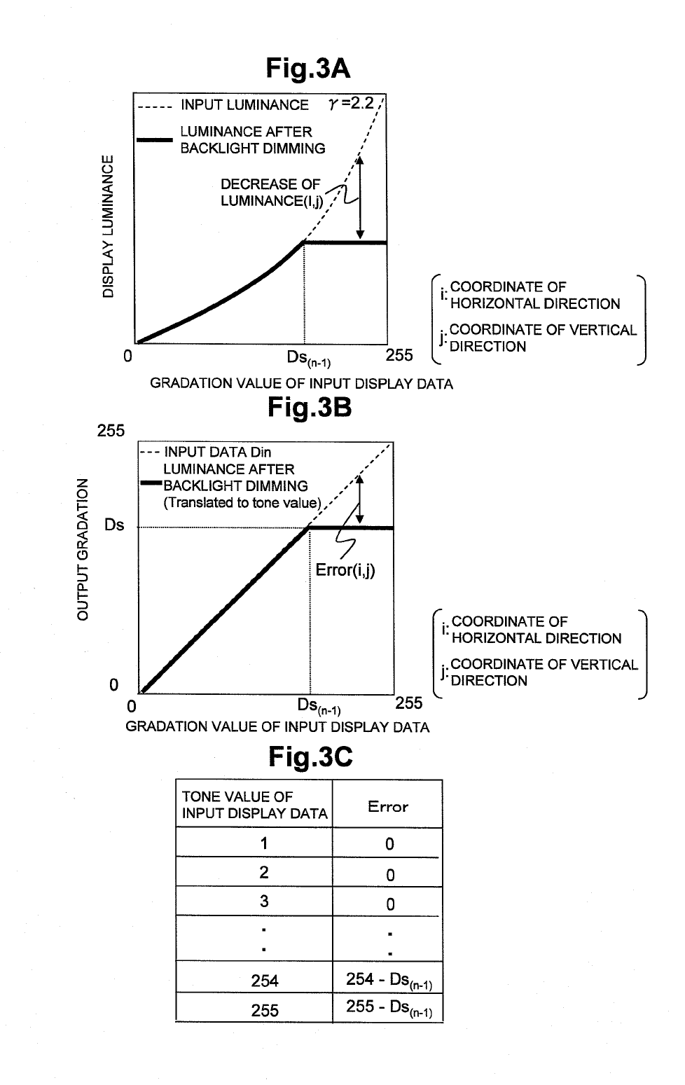

Now, the first specific example of the backlight control circuit 104 will be described with reference to FIG. 2 and FIGS. 3A-3C. The backlight control circuit 104 participates in the materialization of a technique for reducing the power requirements of backlights according to the invention, and controls the decompression ratio of display data and backlight dimming ratio so that MSE or PSNR is unchanged in value between a current output image and preceding one regardless of the histogram of the luminances (gradations) of pixels involved with a displayed image. The backlight control circuit 104 materialized according to the invention is arranged as follows.

The backlight control circuit 104 has: an MSE calculating circuit 203 as an error calculating unit; a Ds control circuit 205 as a reference gradation control unit; a data decompression circuit 220 as a decompression unit; and a backlight voltage generator 230 as a light-adjustment control unit.

The MSE calculating circuit 203 accepts, as inputs, input display data Din (200), a frame SYNC 201 showing a one-frame period, and gradation data Ds₍ₙ₋₁₎ fed back from the preceding frame, which is denoted by the numeral 202. When decompressing data based on gradation data Ds₍ₙ₋₁₎ denoted by the numeral 202 to dim the backlight, the MSE calculating circuit 203 calculates MSE (Mean Square Error) as an index of what extent the luminance will reduce to, and transmits a result of the calculation to the Ds control circuit 205 of the subsequent stage. The gradation data Ds represents a reference gradation used as a criterion for deciding the backlight dimming ratio and the expansion ratio of display data. For instance, if 256 gradations are used for display, the gradation data Ds takes on a value meeting the condition of:

0<Ds<255.

Next, the MSE calculating circuit 203 will be described with reference to FIGS. 3A-3C. Given the gamma characteristic, the amount of decrease in luminance in the display unit can be replaced with an input data value. Therefore, the means for determining MSE includes the following steps. First, an amount of decrease in luminance of a coordinate (i,j) shown in FIG. 3A is translated into a value of reduction in display data Error (i,j) shown in FIG. 3B. The translation table shown in FIG. 3C, which conforms to Expression 1, is used for this translation. A method using no such table may be adopted for the translation as long as it takes a mode such that a reduction of luminance is translated into a data value. Next, based on Errors (i,j) of all pixels, MSE is calculated according to Expression 2.

$$\begin{matrix} Din ( i , j ) \leq {Ds}_{( n - 1 )} \text{:} Error ( i , j ) = 0 \\ Din ( i , j ) > {Ds}_{( n - 1 )} \text{:} Error ( i , j ) = Din ( i , j ) - {Ds}_{( n - 1 )} \\ or \\ Error ( i , j ) = Din ( i , j ) - Dbl ( i , j ) & [ Number 1 ] \\ MSE = \frac{1}{mn} {\sum }_{i = 0}^{m - 1} {\sum }_{j = 0}^{n - 1} {Error ( i , j )}^{2} & [ Number 2 ]\end{matrix}$$

m: number of pixels in horizontal direction

n: number of pixels in vertical direction

The Ds control circuit 205 accepts, as inputs, an MSE from the MSE calculating circuit 203, gradation data Ds₍ₙ₋₁₎ denoted by the numeral 202, and MSE reference value k (204) from the outside, performs addition and subtraction of gradation data Ds₍ₙ₋₁₎ denoted by the numeral 202 so that the MSE becomes equal to the MSE reference value k (204), and then transmits the resulting data Ds(n) to the data decompression unit 220 and backlight control circuit 230 of subsequent stages. In a more preferred embodiment, the Ds control circuit 205 increases the data Ds₍ₙ₋₁₎ denoted by the numeral 202 by a number of A in gradation in the case of the MSE larger than the MSE reference value k, and decreases the data Ds₍ₙ₋₁₎ denoted by the numeral 202 by the number of A in gradation in the case of the MSE smaller than the MSE reference value k, which are as expressed by:

MSE<k:Ds−A(Ds is decreased)

MSE≧k:Ds+A(Ds is increased) [Number 3]

A: A fixed number between zero and the maximum number of gradation, which can be set by an external register.

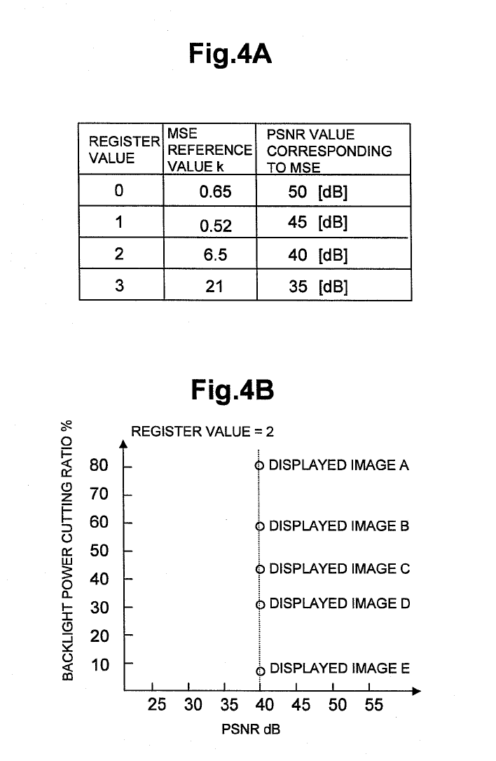

According to the forms of the MSE calculating circuit 203 and Ds control circuit 205 as described above, the data Ds₍ₙ₎ denoted by the numeral 206 is shifted so that MSE converges to the MSE reference value k (204) regardless of a displayed image. Incidentally, the MSE reference value k can be changed by an external register as shown in FIG. 4A. Further, the number A can be varied to an appropriate constant by the control register 103 outside it.

In regard to this embodiment, it is desirable to avoid changing the decompression ratio and dimming ratio in case that MSE is in a range of “MSE reference value k+B (B is an appropriate constant)”. This is because MSE does not converge on condition that A>1, and MSE is between a value given by “MSE reference value k+A” and the MSE reference value k denoted by the numeral 204. With this embodiment, the numerical value “A” is defined as an appropriate constant. However, if the difference between the value of MSE and MSE reference value k (204) is small, it is sufficient to shift the numerical value “A” in a small range.

The data decompression unit 220 accepts, as inputs, input display data and data Ds₍ₙ₎ 206 from the Ds control circuit 205. Then, data decompression unit 220 decompresses the display data so that the data Ds₍ₙ₎ 206 achieves the maximum gradation, and outputs to the graphic RAM 105.

The data decompression unit 220 will be described further. First, the display data decompression coefficient calculating unit 221 uses the data Ds₍ₙ₎ 206 to carry out a computation of 255/Ds(n). In this step, the display data decompression coefficient “e” denoted by the numeral 222 is calculated so that the data Ds₍ₙ₎ 206 achieves the maximum gradation. Next, in the multiplication unit 223, the display data decompression coefficient “e” 222 is multiplied by the input display data Din 200, and the result of the multiplication is set as a parameter P. If the result of the multiplication exceeds 255, the operation unit 224 executes a saturate operation by which the parameter P is substituted with 255. Finally, the operation unit 225 performs a truncation to the closest whole number, and outputs the decompression display data thus acquired to the graphic RAM 105. The multiplication by the operation unit 223 is executed for each of R, G and B pixels of image data. Gradations are assigned within a range of 256 depending on colors produced by colors of R, G, and B. Therefore, the multiplication of the display data decompression coefficient by display data represents a change in the gradation of a pixel, or a change in the luminance of a pixel.

The backlight voltage generator 230 accepts data Ds₍ₙ₎ denoted by 207 as an input, in which reference is made to the table 231 with the data Ds₍ₙ₎, whereby a backlight voltage select signal 232 is produced and output to the backlight module 116.

By executing a series of the forms of actions, an output display can be made to converge, over a few frames, to the image quality of PSNR corresponding to the MSE reference value k with respect to input display data. Examples of the correspondence between MSE and PSNR values are shown in FIG. 4A. Now, the case where the MSE reference value k denoted by the numeral 204 is set to 6.5 will be described as an example with reference to FIG. 4B. The MSE reference value k=6.5 corresponds to a PSNR value of 40 [dB]. The image quality after backlight dimming is independent of the distribution of luminances in a displayed image. The input display data is regarded to be 40 [dB] with respect to a preceding frame of image data.

<<Handling of Solid Image>>

Now, the second specific example of the backlight control circuit, on which an arrangement is made to provide for a solid image, will be described. As for a so-called solid image whose input displayed image is formed in a monochrome and monogradation, it has been revealed from the study by the inventors that the reduction in luminance is more difficult to visually recognize in comparison to other images. Hence, the description here pertains to a backlight control circuit additionally provided with the function of adjusting a displayed image consisting of solid one in whole or an image having a high percentage of solidly displayed areas therein—both herein referred to as “solid image” simply—to increase the decompression ratio of the displayed image data and the backlight dimming ratio, and is presented in contrast to the backlight control circuit 104 of FIG. 2.

FIG. 5 shows an example of the backlight control circuit additionally provided with the function of adjusting a solid image to increase the decompression ratio of the data and the backlight dimming ratio. The backlight control circuit includes an MSE calculating circuit 203, a Ds control circuit 205, a data decompression circuit 220 and a backlight voltage generator 230. In this respect, the backlight control circuit shown in FIG. 5 is similar to that shown in FIG. 2. However, the backlight control circuit shown in FIG. 5 is different in that it further includes a solid image judging circuit 501 used as a percentage judging unit, and a reference value weighting circuit 504.

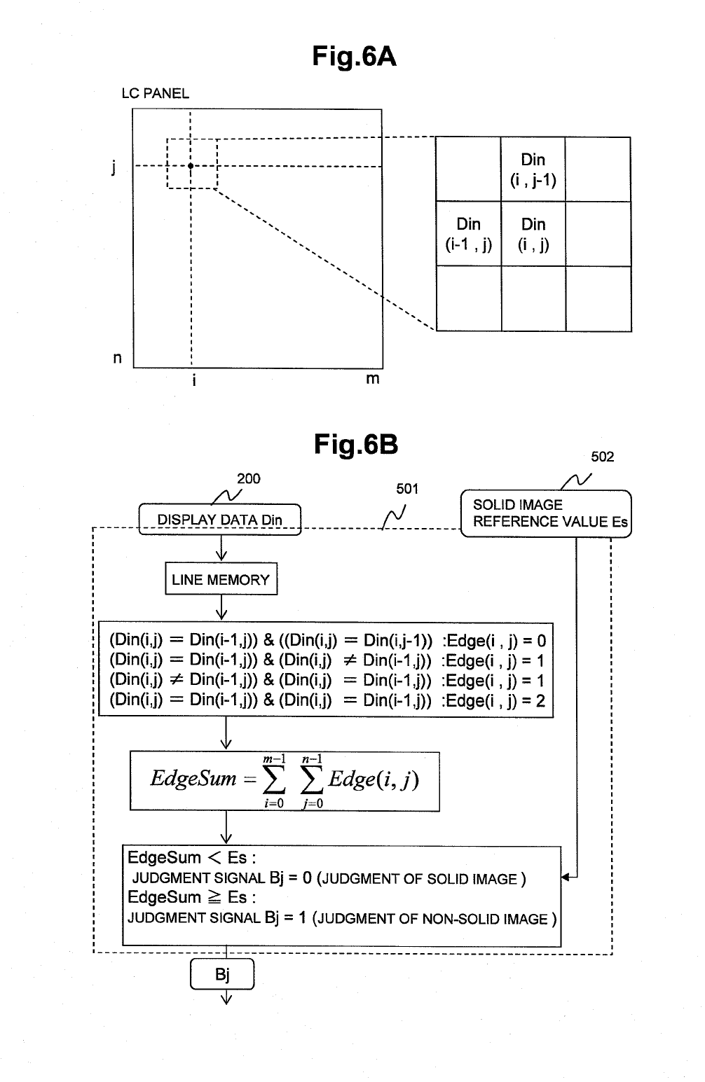

Next, the difference between the backlight control circuit of FIG. 5 and that of FIG. 2 will be described. The solid image judging circuit 501 accepts, as inputs, input display data Din 200 and a solid image reference value Es denoted by the numeral 502. On receipt of the inputs, the solid image judging circuit 501 makes a judgment about whether the input display data comes from a solid image, and outputs a judgment signal Bj denoted by the numeral 503. Now, actions inside the solid image judging circuit 501 will be described with reference to FIGS. 6A and 6B. First, the solid image judging circuit 501 grasps the information about whether or not there is a difference in gradation between display data Din (i,j) of interest and e.g. display data Din (i,j-1) and Din (i-1, j) located on the left and upper sides of and next to the display data Din (i,j) as shown in FIG. 6A. The process procedure pertaining to this action is shown in FIG. 6B. If the value of display data Din (i,j) of input display data lying in the i-th place in a horizontal direction and in the j-th place in a vertical direction is identical to both the values of the data Din (i,j-1) and Din (i-1,j), an edge count value Edge(i,j) is set to zero (0), otherwise the number of disagreements, i.e. one (1) or two (2) is set as the edge count value Edge(i,j). The solid image judging circuit 501 accumulates the edge count value Edge (i,j) for all pixels of display data representing one frame, and then calculates EdgeSum defined as the value resulting from the accumulation. If the EdgeSum is smaller than a predetermined constant Es, the solid image judging circuit 501 judges the input display data of interest to be a solid image, and outputs a judgment signal Bj=0 denoted by the numeral 503. If the EdgeSum is larger than the constant Es, the solid image judging circuit 501 judges the input display data to be other image except a solid image, and outputs a judgment signal Bj=1 denoted by the numeral 503. Now, it is noted that the constant Es, denoted by the numeral 502, is a fixed number which can be changed by the external control register 103.

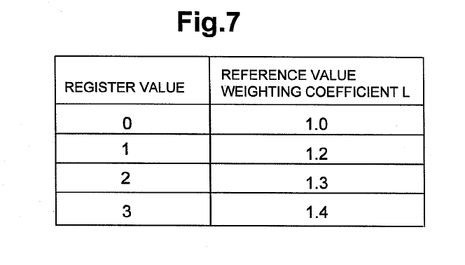

The reference value weighting circuit 504 receives, as inputs, a reference value weighting coefficient L input from the outside and denoted by the numeral 505, and a judgment signal Bj (503) from the solid image judging circuit 501. On receipt of the inputs, the reference value weighting circuit 504 multiplies the MSE reference value k by the coefficient L (L>1) in the case of Bj=0, and multiplies by one (1) in the case of Bj=1, and then outputs a result of the multiplication to the Ds control circuit 205 of the subsequent stage. The setting of the MSE reference value weighting coefficient L (505) can be changed by the control register 103 as shown in FIG. 7.

According to the arrangement as described above, the backlight dimming ratio can be made larger in comparison to that achieved by the backlight control circuit of FIG. 2 on condition that a displayed image is solid one.

According to another embodiment, the backlight control circuit may be arranged to have, instead of the reference value weighting circuit 504, a circuit located in a stage subsequent to the MSE calculating circuit 203, which accepts, as inputs, the judgment signal Bj and MSE, and weights MSE, and multiplies MSE by P (P<1) on condition that a displayed image is solid one.

<<Measure to Handle an Image with Many Flesh-Colored Portions>>

A portrait image containing many flesh-colored pixels is easier for the backlight control circuit of FIG. 2 to visually recognize the reduction in luminance in comparison to an image dealing with a different subject. Here, the third specific example of the backlight control circuit further including the function of adjusting the backlight dimming ratio to prevent the luminance of a flesh-colored pixel from being reduced on condition that a displayed image contains a flesh-colored pixel will be described in contrast to the backlight control circuit of FIG. 2. FIG. 8 shows the backlight control circuit so arranged. The backlight control circuit 104 of FIG. 8 includes an MSE calculating circuit 203, a Ds control circuit 205, a data decompression circuit 220, and a backlight voltage generator 230. In this respect, the backlight control circuit shown in FIG. 8 is similar to the backlight control circuit in connection with the first embodiment. However, the backlight control circuit shown in FIG. 8 is different in that it further includes a flesh-color detector 801 as a flesh-color percentage judging unit, and a reference value weighting circuit 804. The difference between the backlight control circuit of FIG. 8 and that of FIG. 2 will be described below.

The flesh-color detector 801 accepts input display data as an input. On receipt of the input, the flesh-color detector calculates a hue H for each pixel according to the following expression:

$$H = 60 \times \frac{G - B}{MAX - MIN} if MAX = R \\ H = 60 \times \frac{B - R}{MAX - MIN} + 120 if MAX = G \\ H = 60 \times \frac{R - G}{MAX - MIN} + 240 if MAX = B \qquad [ Number 4 ]$$

The flesh-color detector outputs a judgment signal Hj=0 if the hue H is in a range between 0 and 30, which corresponds to a hue region of flesh color, and it outputs a judgment signal Hj=1 if the hue H is between 30 and 360. In this example, a hue is used to identify flesh color, however the identification may be actualized by other means using a color saturation, lightness or RGB, or a combination thereof as long as flesh color can be identified.

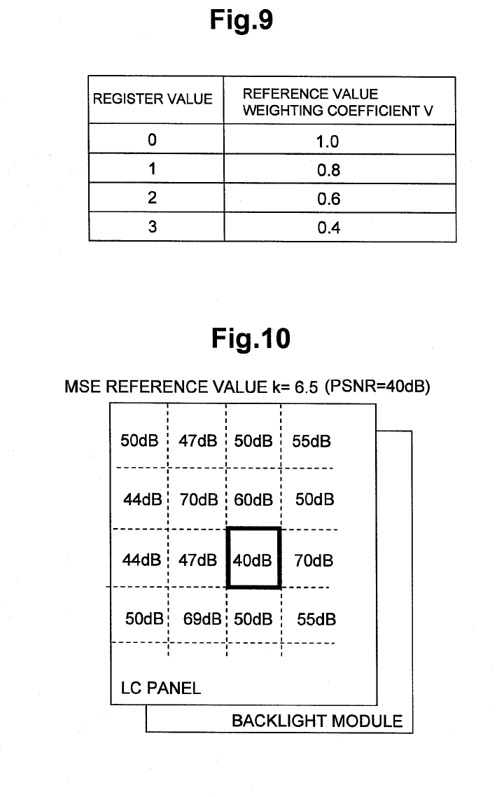

The reference value weighting circuit 804 accepts, as inputs, a reference value weighting coefficient V (803) from the outside and a judgment signal Hj (802) from the flesh-color detector 801. On receipt of the inputs, the reference value weighting circuit 804 multiplies the MSE reference value k by V (V<1) when Hj=0, and multiplies by one (1) when Hj=1, and then outputs a result of the multiplication to the Ds control circuit 205 of the subsequent stage. The setting of the reference value weighting coefficient V (803) can be changed by the control register 103 as shown in FIG. 9.

According to the arrangement as described above, the backlight dimming ratio can be made smaller in comparison to that offered by the backlight control circuit of FIG. 2 on condition that a displayed image contains many flesh-colored pixels, and therefore the image quality of an output display can be increased.

The backlight control circuit as shown in FIG. 8 may be arranged to have, instead of the reference value weighting circuit 804, a circuit located in a stage subsequent to the MSE calculating circuit 203, which accepts, as inputs, the judgment signal Hi (802) and MSE, weights MSE, and multiplies MSE by Q (Q>1) on condition that a displayed image contains flesh-colored pixels.

<<Backlight Control on the Maximum of Errors Calculated for Each Division Area>>

In the backlight control circuit of FIG. 2, MSE of an output display converges to a set value. However, MSE of a local area of a displayed image may be large, which can make the reduction in luminance easier to see concerning a part of the display. Here, the fourth specific example of the backlight control circuit having the function of dividing a display panel into two or more areas as shown in FIG. 10, and adjusting the backlight dimming ratio so that MSE is below a set value for any areas at all times will be described. FIG. 11 shows an example of the arrangement of the backlight control circuit 104. The backlight control circuit 104 shown in FIG. 11 includes a Ds control circuit 205, a data decompression circuit 220, and a backlight voltage generator 230. In this respect, the backlight control circuit shown in FIG. 11 is similar to that shown in FIG. 2. However, the backlight control circuit of FIG. 11 is different from the backlight control circuit of FIG. 2 in that it includes more than one MSE calculating circuit 1002 corresponding in number to data resulting from the division, and additionally includes a maximum MSE select circuit 1004, and a display data area division circuit 1001.

The display data area division circuit 1001 divides display data into two or more parts which correspond in number to display areas resulting from division. Subsequently, the MSE calculating circuit 1002 calculates MSE for each division area based on the resulting data. The maximum MSE select circuit 1003 selects the maximum MSE (MSEmax) from among MSEs making up each of MSE(1) to MSE(t) of the respective division areas, and outputs to the Ds control circuit 205 of the subsequent stage. In this example, the arrangement described with reference to FIGS. 1 to 4A and 4B can be applied to the circuit components, which are not shown in FIG. 10.

Using this arrangement, the Ds control circuit 205 of the subsequent stage controls gradation data Ds based on each MSEmax. Therefore, the backlight dimming ratio is decided so that MSE or PSNR is at or above a certain level as to any division area of the display panel.

<<Backlight Control for Each Division Area on an Error Calculated for Each Division Area>>

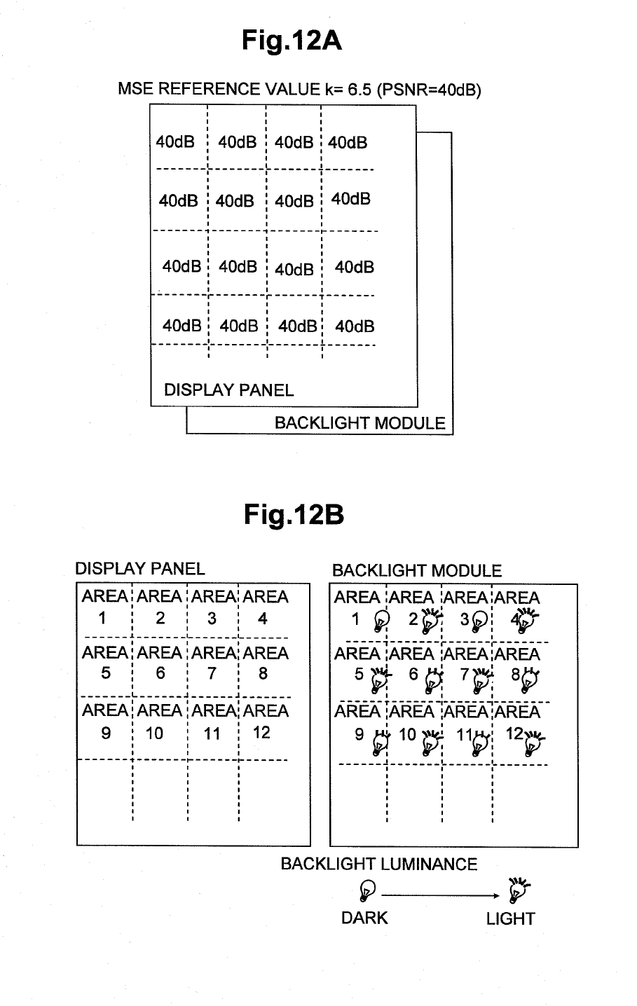

FIG. 13 shows an example of a display system with an LC driver arranged so that MSE or PSNR is kept at a constant value in each division area. FIG. 12A shows the image quality of a displayed image when the display system of FIG. 13 is in use. FIG. 12B shows the amount of light from the backlight at that time in areas of the display panel.

The display system of FIG. 13 has a backlight module for each of areas resulting from division of its display area, and an LC driver 101 capable of adjusting the amount of light emission for each division area independently of remaining division areas. The LC driver 101 includes a display area division circuit 1300 which divides input display data for each display area. The LC driver has, for each divided area, a backlight control circuit 104, a graphic RAM 105, a timing generator 106, a gradation-voltage generator 107, a source-line drive circuit 108, an LC drive level generator 109, and a backlight power-source circuit 110, which are the same as those shown in FIG. 1 in structure, and which are arranged to keep PSNR at a constant value for each display area. The display area division circuit 1300 divides input display data for each display area, and transmits corresponding division-display data to the corresponding backlight control circuit 104 of the subsequent stage. The backlight control circuit 104, graphic RAM 105, timing generator 106, gradation-voltage generator 107, source-line drive circuit 108, LC drive level generator 109, and backlight power-source circuit 110 work the same as those in the LC driver of FIG. 1 except for using divided data, and signals are transmitted to the LC panel display area 1301 and backlight module 1302. Thus, in regard to the display areas resulting from the division, PSNR of output display can be kept at a constant value in any area. Now, it is noted that as to the display system of FIG. 13, the graphic RAM 105 means a RAM area (storage area) for each division-display area. With this example, it is possible to apply the arrangement described with reference to FIGS. 1 to 4A and 4B to the circuit components, which are not shown in FIG. 13.

In the example described here, the LC driver has the backlight control circuit 104, graphic RAM 105, timing generator 106, gradation-voltage generator 107, source-line drive circuit 108, LC drive level generator 109, and backlight power-source circuit 110 for each division area. However, the LC driver may be arranged to have only one set of these parts, and to handle the data for each display area according the time division technique.

The invention made by the inventor has been concretely described above based on the embodiments thereof. However, the invention is not limited to the embodiments. It is obvious that various changes and modifications may be made without departing from the subject matter thereof.

For instance, in the above description, MSE is cited as the error between a display luminance corresponding to input display data and a display luminance after backlight adjustment. However, an index other than MSE may be adopted as long as it represents the difference of luminance.

What is claimed is:

1. A display driver operable to drive a display panel in response to input display data, comprising:
a decompression unit which accepts input of a reference gradation, and decompresses the input display data so as to maximize the reference gradation;
a light-adjustment control unit which adjusts light of a backlight in response to the reference gradation;
an error calculating unit which calculates an error between a display luminance corresponding to the input display data and a display luminance after adjustment of light of the backlight; and
a reference gradation control unit which changes the reference gradation so that a result of the error calculation by the error calculating unit becomes equal to a first reference value.

2. The display driver according to claim 1, wherein the decompression unit multiplies a value of each pixel component of display data by a coefficient to maximize the reference gradation, thereby to decompress the display data.

3. The display driver according to claim 1, wherein the error calculating unit calculates an error between a luminance of display data of a current display frame, and a luminance obtained by decompressing the display data of the current display frame by use of a reference gradation of a preceding display frame.

4. The display driver according to claim 1, wherein MSE (Mean Square Error) is used as the error.

5. The display driver according to claim 1, wherein the first reference value in connection with the reference gradation control unit can be changed by a value set in a register from outside the display driver.

6. The display driver according to claim 4, wherein in the gradation control unit, a gradation number of the reference gradation varied in every frame is changed as to one of a value set in a register from outside the display driver, and a numerical value of MSE (Mean Square Error).

7. The display driver according to claim 1, wherein the error calculating unit calculates an error for each of displayed areas of the display panel, and
the reference gradation control unit changes the reference gradation so that a maximum of results of the error calculations on an individual displayed area basis becomes equal to the first reference value.

8. A display driver operable to drive a display panel in response to input display data, comprising:
a decompression unit which accepts input of a reference gradation, and decompresses the input display data so as to maximize the reference gradation;
a light-adjustment control unit which adjusts light of a backlight in response to the reference gradation;
an error calculating unit which calculates MSE (Mean Square Error) between a display luminance corresponding to the input display data and a display luminance after adjustment of light of the backlight;
a percentage judging unit which judges a percentage of the display data input for a duration of one frame occupied by a certain type of information; and
a gradation control unit which changes the reference gradation so that a result of the MSE calculation by the error calculating unit becomes equal to one of first and second reference values, according to a result of judgment made by the percentage judging unit,
wherein the gradation control unit changes the reference gradation by use of the first reference value on condition that the percentage of the display data input for the duration of one frame occupied by the certain type of information is smaller than a third reference value, and
the gradation control unit changes the reference gradation by use of the second reference value on condition that the percentage of the display data input for the duration of one frame occupied by the certain type of information is larger than the third reference value.

9. The display driver according to claim 8, wherein the first to third reference values can be each changed by a value set in a register from outside the display driver.

10. The display driver according to claim 9, wherein the second reference value is larger than the first reference value.

11. The display driver according to claim 10, wherein in the gradation control unit, a difference between reference gradations before and after change thereof is changed as to one of a value set in a register from outside the display driver, and a numerical value of MSE (Mean Square Error).

12. The display driver according to claim 8, wherein the certain type of information contained by the input display data is information of being identical in gradation.

13. The display driver according to claim 8, wherein the certain type of information contained by the input display data is information of being flesh-colored.

14. The display driver according to claim 13, wherein the percentage judging unit operable to judge flesh color has functions of: translating the input display data into all or one of hue, color saturation, and lightness; and identifying flesh color from all or one of the hue, color saturation and lightness.

15. A display driver operable to individually drive displayed areas of a display panel in response to input display data, comprising:
a decompression unit which accepts input of a reference gradation for each displayed area, and decompresses the input display data so as to maximize the reference gradation;
a light-adjustment control unit which adjusts light of a backlight for the displayed area to be handled in response to the reference gradation of the displayed area;
an error calculating unit which calculates MSE (Mean Square Error) between a display luminance corresponding to the input display data, and a display luminance after adjustment of light of the backlight, for each of the displayed areas of the display panel; and
a reference gradation control unit which changes the reference gradation so that a maximum of results of the error calculations on an individual displayed area basis by the error calculating unit becomes equal to the first reference value.

16. The display driver according to claim 15, wherein the first reference value can be changed by a value set in a register from outside the display driver.

17. The display driver according to claim 16, wherein in the gradation control unit, a gradation number of the reference gradation varied in every frame is changed as to one of a value set in a register from outside the display driver, and a numerical value of MSE (Mean Square Error).
